(19) United States
(12) Patent Application Publication
(10) Pub. No.: US 2011/0150512 A1
(43) Pub. Date: Jun. 23, 2011

(54) IMAGE FORMING APPARATUS

(75) Inventor: Kuniaki Tamagaki, Gotemba-shi (JP)

(73) Assignee: CANON KABUSHIKI KAISHA, Tokyo (JP)

(21) Appl. No.: 12/972,946

(22) Filed: Dec. 20, 2010

(30) Foreign Application Priority Data
Dec. 21, 2009 (JP) 2009-289390
Dec. 14, 2010 (JP) 2010-278410

(51) Int. Cl. G03G 15/08

(52) U.S. Cl. 399/53

(57) ABSTRACT

An image forming apparatus to which a cleaning unit is detachably mountable to a main assembly of the apparatus includes a rotatable image bearing drum on which an electrostatic latent image is formed; a developing unit for developing the latent image into a toner image by supplying toner onto a surface of the drum; a cleaning unit including a cleaning blade for cleaning the drum by contacting to the surface of the image bearing member when the drum is rotating; a storing portion for storing information relates to a use amount of the developing unit; and a control device capable of executing toner supply into between the surface of the drum and the cleaning blade by supplying the toner to the surface of the drum from the developing unit in a period in which image formation on a sheet material is not executed, wherein when the toner supply is executed, the control device increases the amount of the toner to the surface of the drum from the developing unit with increase of the use amount of the developing unit on the basis of the information stored in the storing portion.

### FIELD OF THE INVENTION AND RELATED ART

The present invention relates to an image forming apparatus. Some image forming apparatuses employ an electrophotographic image forming method.

There have been known image forming apparatuses having: a rotatable image bearing member, on the peripheral surface of which an electrostatic latent image is formed; a development unit which develops the electrostatic latent image into a toner image, that is, an image formed of toner; and a cleaning apparatus which removes the toner remaining on the peripheral surface of the image bearing member after the transfer of the toner image. The cleaning apparatuses which have been known to be employable as the cleaning apparatus for an image forming apparatus, are cleaning apparatuses which have: a cleaning blade which is placed in contact with the peripheral surface of an image bearing member to scrape away the residual toner on the peripheral surface of the image bearing member; and a waste toner container in which the residual toner is to be stored after being scraped away from the peripheral surface of an image bearing member.

However, a cleaning apparatus which employs a cleaning blade suffers from the following phenomenon. That is, when the residual toner is scraped away by the cleaning blade of the cleaning apparatus, if the friction between the cleaning blade and the peripheral surface of an image bearing member is large, the cleaning blade chatters or shudders (sticks and slides), and/or is bent away from the peripheral surface of the image bearing member in the direction in which the peripheral surface of the image bearing member is being moved. Not only the occurrence of the phenomenon such as those described above which prevents the peripheral surface of an image bearing member from being satisfactorily cleaned, but also, scars the peripheral surface of an image bearing member, causing thereby an image forming apparatus to reduce in image quality. Further, shuddering and chattering of a cleaning blade result in the generation of abnormal sounds. As one of the solutions to prevent these problems, there is the art disclosed in Japanese Laid-open Patent Application H10-161426. According to this art, in order to satisfactorily clean the peripheral surface of an image bearing member while preventing the image forming apparatus from generating the above described abnormal sounds, the peripheral surface of the image bearing member is supplied with a certain amount of toner dedicated to lubrication to reduce the friction between the cleaning blade and the peripheral surface of the image bearing member.

However, an image forming apparatus in accordance with the above described art suffers from the following problem.

Generally speaking, as a development unit increases in usage, the external additives on the surface of a toner particle in the development unit become embedded in the toner particle, because the toner is rubbed by the other toner particles in the development unit and/or the development roller, and the like, of the development unit. That is, the toner surface reduces in the amount of external additive; in other words, the toner in the development unit deteriorates. The amount by which toner is to be supplied to the peripheral surface of an image bearing apparatus to lubricate the peripheral surface of the image bearing member is significantly affected by the amount of the external additives on the surface of a toner particle. Thus, if the toner in a development unit has deteriorated, the peripheral surface of an image bearing member cannot be satisfactorily lubricated unless the amount by which the toner is delivered to the peripheral surface of the image bearing member is substantial.

### SUMMARY OF THE INVENTION

Thus, the primary object of the present invention is to provide an image forming apparatus which is superior to any of the image forming apparatuses in accordance with the prior art, in terms of the capability to reduce the friction between a cleaning blade and the peripheral surface of an image bearing member by supplementally delivering the peripheral surface of the image bearing member with toner.

According to an aspect of the present invention, there is provided an image forming apparatus to which a cleaning unit is detachably mountable to a main assembly of the apparatus, comprising a rotatable image bearing member on which an electrostatic latent image is formed; a developing unit for developing the electrostatic latent image into a toner image by supplying toner onto a surface of said image bearing member; a cleaning unit including a cleaning blade for removing toner from the surface of said image bearing member by contacting to the surface of said image bearing member when said image bearing member is rotating; a storing portion for storing information relates to a use amount of said developing unit; and a control device capable of executing toner supply into between the surface of said image bearing member and said cleaning blade by supplying the toner to the surface of said image bearing member from said developing unit in a period in which image formation on a sheet material is not executed, wherein when the toner supply is executed, said control device increases the amount of the toner to the surface of said image bearing member from the developing unit with increase of the use amount of said developing unit on the basis of the information stored in said storing portion.

According to another aspect of the present invention, there is provided an image forming apparatus comprising a rotatable image bearing member on which an electrostatic latent image is formed; a developing unit for developing the electrostatic latent image into a toner image by supplying toner onto a surface of said image bearing member; a cleaning unit including a cleaning blade for removing toner from the surface of said image bearing member by contacting to the surface of said image bearing member when said image bearing member is rotating; a storing portion for storing information relates to a use amount of said developing unit; and a control device capable of executing toner supply into between the surface of said image bearing member and said cleaning blade by supplying the toner to the surface of said image bearing member from said developing unit in a period in which image formation on a sheet material is not executed, wherein when the toner supply is executed, said control device controls such that the amount of the toner to the surface of said image bearing member from the developing unit is increased with increase of the use amount of said developing unit on the basis of the information stored in said storing portion.

These and other objects, features, and advantages of the present invention will become more apparent upon consideration of the following description of the preferred embodiments of the present invention, taken in conjunction with the accompanying drawings.

### BRIEF DESCRIPTION OF THE DRAWINGS

FIG. 1 is a schematic sectional view of the image forming apparatus of the image forming apparatus in the first preferred embodiment of the present invention, and shows the general structure of the apparatus.

FIG. 2A is a block diagram of the controlling apparatus of the image forming apparatus in the first preferred embodiment, and FIG. 2B is a flowchart of the control sequence for delivering toner solely for lubrication.

FIG. 3A is a block diagram of the portion of the image forming apparatus in the second preferred embodiment of the present invention, which is for detecting whether or not the development unit in the main assembly of the image forming apparatus is brand-new, and FIG. 3B is a flowchart of the control sequence for delivering toner solely for lubrication.

FIG. 4A is a block diagram of the controlling apparatus of the image forming apparatus in the second preferred embodiment, and FIG. 4B is a flowchart of the control sequence for delivering toner solely for lubrication.

### DESCRIPTION OF THE PREFERRED EMBODIMENTS

Hereinafter, referring to the appended drawings, the present invention is described in detail with reference to preferred embodiments of the present invention. The measurements, sizes, and shapes of the structural components of the image forming apparatuses, and their positional relationship, in the following embodiments of the present invention are not intended to limit the present invention in scope, unless specifically noted.

### Embodiment 1

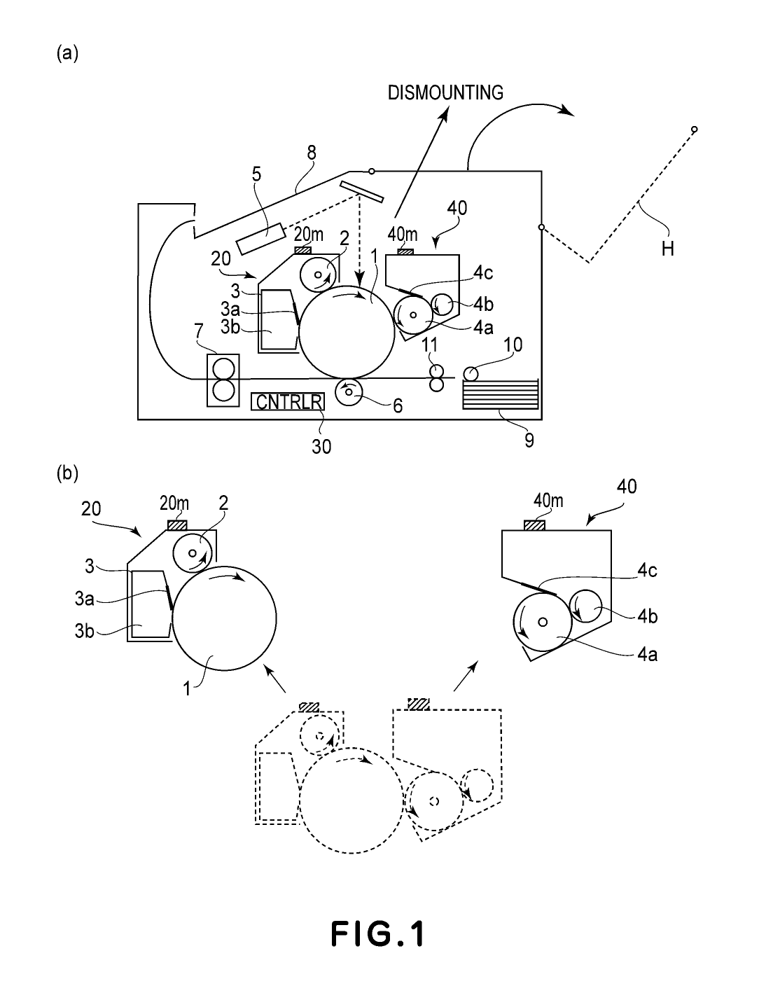

First, referring to FIGS. 1(a) and 1(b), the structure of the image forming apparatus in this embodiment of the present invention is described. The image forming apparatus in this embodiment is a laser beam printer which employs an electrophotographic image forming method.

### 1-1: General Structure of Image Forming Apparatus

First, referring to FIGS. 1(a) and 1(b), the general structure of the image forming apparatus in this embodiment is described. FIG. 1(a) is a schematic sectional view of the image forming apparatus in this embodiment, and shows the general structure of the apparatus. FIG. 1(b) is the combination of the development unit and cleaning unit in this embodiment, and shows their structure.

The image forming apparatus has a photosensitive drum 1 which is a rotatable image bearing member. The photosensitive drum 1 comprises an aluminum cylinder, and a combination of an undercoating layer, a charge generation layer, and a charge transferring layer which are coated in the listed order on the peripheral surface of the aluminum cylinder. The image forming apparatus is structured so that the photosensitive drum is rotatable by an unshown power source in the direction indicated by an arrow mark. The image forming apparatus has also a charge roller 2, a development unit 40, a transfer roller 6, and a cleaning apparatus 3, which are arranged in the adjacencies of the peripheral surface of the photosensitive drum 1, in the listed order in terms of the direction in which the photosensitive drum 1 is rotated. The image forming apparatus has also an exposing apparatus 5 which is above the photosensitive drum 1 and scans (exposes) the peripheral surface of the photosensitive drum 1 with the beam of laser light it projects.

The development unit 40 has: a development roller 4a which is placed in contact with the peripheral surface of the photosensitive drum 1; a toner supply roller 4b which is placed in contact with the peripheral surface of the development roller 4a; a toner layer thickness regulation blade 4c which is placed virtually in contact with the peripheral surface of the development roller 4a; and a toner container in which the preceding components of the development unit 40 are placed together. The image forming apparatus is structured so that the development roller 4a and toner supply roller 4b are rotatable together in the direction indicated by arrow marks. The external frame of the development unit 40 is provided with an opening which faces the peripheral surface of the photosensitive drum 1. The portion of the peripheral surface of the development roller 4a, which faces this opening is in contact with the peripheral surface of the photosensitive drum 1. The toner container contains nonmagnetic single-component developer, which is black in color and negatively chargeable. This tone is delivered to the peripheral surface of the photosensitive drum 1 by the so-called nonmagnetic single-component developing method. Incidentally, the “toner (developer)” in this embodiment is a mixture of toner particles (particles made of pure toner) and external additive particles.

With the image forming apparatus being structured as described above, as the toner supply roller 4b is rotated, the toner in the toner container is supplied to (coated on) the peripheral surface of the development roller 4a. After being supplied to the peripheral surface of the development roller 4a, the toner layer formed on the peripheral surface of the development roller 4a is regulated in thickness by the toner layer thickness regulation blade 4c. Then, as a development voltage, which is the same in polarity as the toner, is applied to the development roller 4a from an unshown electric power source, the toner is transferred from the peripheral surface of the development roller 4a to the peripheral surface of the photosensitive drum 1. Incidentally, the toner remaining on the peripheral surface of the development roller 4a after the transfer, that is, the toner which was not transferred to the peripheral surface of the photosensitive drum 1 from the peripheral surface of the development roller 4a, can be scraped away from the peripheral surface of the development roller 4a by the toner supply roller 4b. The development unit 40 is provided with a nonvolatile memory (which hereafter will be referred to as DT memory 40m) in which the cumulative mount of usage of the development unit 40 is stored. The DT memory is capable of storing the cumulative amount of usage of the development unit 40, which is detected by an unshown detecting means. In this embodiment, the image forming apparatus is provided with such a detecting portion that counts the number of rotations of the development roller 4a. The number of rotations of the development roller 4a detected by this portion is stored in the DT memory 40m. However, the image forming apparatus may be structured so that the counted number of rotations of the development roller 4a (cumulative number of prints formed by image forming apparatus), or the remaining amount of toner in the development unit 40, which is detected by an optical means, is stored as the “cumulative amount of usage of the development unit 40”, in the DT memory 40m. Further, the image forming apparatus is structured so that the controlling apparatus 30 of the main assembly of the image forming apparatus can communicate with the DT memory 40m (write information in DT memory 40m, or read information in DT memory 40m) without being placed in contact with the DT memory 40m, or by being electrically in contact with the DT memory 40m through electrical contacts.

The photosensitive drum 1, charge roller 2, and cleaning apparatus 3 are held together, making up thereby a cleaning unit 20. The cleaning apparatus 3 has: a cleaning blade 3a, which is placed in contact with the peripheral surface of the photosensitive drum 1 at such an angle that its cleaning edge is on the upstream of its base portion in terms of the moving direction of the peripheral surface of the photosensitive drum 1; and a waste toner container 3b. The cleaning blade 3a in this embodiment is formed of rubber. With the cleaning apparatus 3 being structured as described above, the aforementioned residual toner on the peripheral surface of the photosensitive drum 1 can be scraped away (removed) by the cleaning blade 3a in the area of contact between the peripheral surface of the photosensitive drum 1 and the cleaning edge of the cleaning blade 3a. After being scraped away from the peripheral surface of the photosensitive drum 1, the residual toner is stored in the waste toner container 3b through the aforementioned opening of the cleaning unit frame, which faces the peripheral surface of the photosensitive drum 1. After being stored in the waste toner container 3b, the residual toner can be used for the next image formation.

The cleaning unit 20 is provided with a nonvolatile memory (which hereafter will be referred to as C memory 20m) as the memory for storing the cumulative amount of usage of the cleaning apparatus 3 (in other words, C memory 20m is an integral part of cleaning apparatus 3). The C memory 20m is capable of storing the cumulative amount of usage of the cleaning unit 20 (whether or not cleaning unit 20 is brand-new). Incidentally, the image forming apparatus is structured so that the controlling apparatus 30 of the main assembly of the image forming apparatus can communicate with the C memory 20m (write information into, or read information from, C memory 20m), without being in contact with the C memory 20m, or by being placed in contact with the C memory 20m through electric contacts.

Next, referring to FIG. 1(b), the above described development unit 40 and cleaning unit 20 (cleaning apparatus 3) are structured so that they can be removably mountable in the main assembly of the image forming apparatus. Incidentally, the “main assembly” of the image forming apparatus means the image forming apparatus minus the development unit 40 and cleaning unit 20. These units are removably mountable in the main assembly of the image forming apparatus through the abovementioned opening by exposing the opening by opening a door H of one of the external walls of the main frame of the apparatus main assembly (direction in which units are mounted into, or dismounted from is shown in FIG. 1(a)). The status of the door H (whether or not door H is open) and the status of the units (whether or not units are in apparatus main assembly) can be detected by an unshown detecting means. The employment of the above described structural features makes it easy for a user to perform maintenance operations, such as removing jammed paper or the like, replenishing the development unit 40 with toner, etc. Thus, it improves the image forming apparatus in usability.

Next, the process for forming an image on a sheet of recording medium with the use of the image forming apparatus structured as described above is described. First, the main power source of the image forming apparatus is to be turned on. As the main power source is turned on, the photosensitive drum 1 and other rotatable members in the apparatus main assembly are preparatorily rotated. As soon as the preparatory rotation of these components has ended, charge voltage (which is the same polarity as toner) begins to be applied to the charge roller 2, whereby the peripheral surface of the photosensitive drum 1 begins to be uniformly charged to the negative polarity. Then, the peripheral surface of the rotating photosensitive drum 1 is scanned with (exposed to) the beam of laser light projected from an exposing apparatus 5 while being modulated with image formation signals inputted from an external signal source such as a PC. As a result, an electrostatic latent image is formed on the peripheral surface of the photosensitive drum 1. Then, toner is transferred onto the electrostatic latent image from the development roller 4a, whereby the electrostatic latent image is developed into a visible image, that is, an image formed of toner (which hereafter will be referred to simply as toner image). Then, the toner image on the peripheral surface of the photosensitive drum 1 is transferred onto a sheet of recording medium, in the transfer nip formed by the photosensitive drum 1 and transfer roller 6, by applying transfer voltage, which is opposite in polarity to the toner, to the transfer roller 6. As for the toner remaining on the peripheral surface of the photosensitive drum 1 after the transfer, that is, the toner which was not transferred, it is scraped away by the abovementioned cleaning blade 6a from the peripheral surface of the photosensitive drum 1.

After the transfer of the toner image onto the sheet of recording medium, the sheet is conveyed to a fixing apparatus 7, in which the toner image is fixed to the sheet of recording medium by being subjected to the heat and pressure applied by the fixing apparatus 7. After the fixation of the toner image, the sheet is discharged into a delivery tray 8, which is a part of the top portion of the image forming apparatus. Further, the image forming apparatus in this embodiment is provided with a sheet feeder cassette 9, which is in the bottom portion of the image forming apparatus. Each sheet of recording medium in the sheet feeder cassette 9 is conveyed to the transfer nip with a preset timing, by way of a sheet feeder roller 10, a pair of recording sheet conveyance rollers 11, etc. . . . The image formation process described above is under the control of the controlling apparatus 30 with which the apparatus main assembly is provided.

### 1-2: Lubricational Toner Delivery Process

If the friction between the cleaning blade 3a and the peripheral surface of the photosensitive drum 1 is large, such a phenomenon that the cleaning blade 3a shudders or chatters (sticks and slips), and/or that the cleaning blade 3a is bent in the same direction as the moving direction of the peripheral surface of the photosensitive drum 1 may occur. It is possible that the occurrence of such a phenomenon will cause the image forming apparatus to output unsatisfactory images. In this embodiment, therefore, a “lubricational toner delivery process” is carried out as soon as the main power source of the apparatus main assembly is turned on, or as soon as the door H is opened and closed. The “lubricational toner delivery process” is such a process that determines whether or not the peripheral surface of the photosensitive drum 1 needs to be supplied with toner for lubrication, and supplies the peripheral surface of the photosensitive drum 1 with toner if necessary. In this embodiment, the “lubricational toner delivery process” is carried out to deliver toner (solely for lubrication) to the peripheral surface of the photosensitive drum 1 when it is determined that the cleaning unit 20 in the apparatus main assembly is brand-new. That is, it is carried out while no image is formed. As lubricational toner is delivered to the peripheral surface of the photosensitive drum 1, it is delivered to the area of contact between the cleaning blade 3a and the peripheral surface of the photosensitive drum 1 by the rotation of the photosensitive drum 1, lubricating thereby the area of contact. Further, in this embodiment, in order to ensure that even if the toner in the container has been reduced in the amount of the external additives on each toner particle, that is, even if the toner container contains deteriorated toner, the image forming apparatus is satisfactorily reduced in the amount of friction between the cleaning blade 3a and the peripheral surface of the photosensitive drum 1, the amount by which lubricational toner is delivered to the area of contact between the cleaning blade 3a and the peripheral surface of the photosensitive drum 1 is controlled according to the extent of toner deterioration.

The amount by which the friction between the cleaning blade 3a and the peripheral surface of the photosensitive drum 1 can be reduced by the delivery of lubricational toner is greatly affected by the external additives of the toner. If the toner delivered for lubrication is substantial in deterioration (smaller in the amount of additives on the surface of each toner particle), it is not effective as lubricant (cannot effectively reduce friction). Thus, even if the toner in the toner container is substantial in deterioration, the peripheral surface of the photosensitive drum 1 can be satisfactorily lubricated as long as the amount, by which the toner is delivered for lubrication, is proportional to the extent of toner deterioration. There is a correlation between the extent of the deterioration of toner in the development unit 40, and the cumulative amount of usage of the development unit 40. In this embodiment, therefore, the amount by which toner is delivered for lubrication from the development unit 40 to the peripheral surface of the photosensitive drum 1 is increased in proportion to the cumulative amount of usage of the development unit 40. In this embodiment, the cumulative amount of usage of the development unit 40 is determined based on the cumulative count of rotations of the development roller 4a, which is stored in the DT memory 40m. However, the image forming apparatus may be structured so that the cumulative amount of usage of the development unit 40 is determined based on the remaining amount of toner in the development unit 40 or print count (number of images formed). Next, the process for delivering toner solely for lubrication will be described in detail.

When it is necessary to supply the peripheral surface of the photosensitive drum 1 with toner solely for lubrication, a solid black image is formed as a lubricational toner image on the peripheral surface of the photosensitive drum 1 while the photosensitive drum 1 is rotationally driven. As for the dimension of this lubricational solid black toner image, in terms of the widthwise direction (axial direction of photosensitive drum 1) of the photosensitive drum 1, the solid black toner image is wide enough to cover the entire range of the photosensitive drum 1. In terms of the rotational direction of the photosensitive drum 1, it has a preset dimension. More specifically, the dimension of the solid black toner image in terms of the rotational direction of the photosensitive drum 1 (in terms of secondary scan direction) can be changed by increasing or decreasing the length of time the peripheral surface of the photosensitive drum 1 is to be exposed, according to the amount by which toner is to be delivered solely for lubrication. In this embodiment, the extent of deterioration of the toner in the development unit 40 is estimated based on the cumulative amount of usage of the development unit 40, which is stored in the DT memory 40m. Then, the amount by which toner is to be delivered solely for lubrication is set in proportion to the extent of toner deterioration. That is, the exposure time is increased in proportion to the extent of deterioration of the toner in the development unit 40. The friction between the cleaning blade 3a and the peripheral surface of the photosensitive drum 1 can be reduced by conveying the lubricational toner image, formed as described above, to the area of contact between the cleaning blade 3a and the peripheral surface of the photosensitive drum 1. Incidentally, the method for forming a lubricational toner image on the peripheral surface of the photosensitive drum 1 does not need to be limited to the above described one, that is, the “charging-exposing-developing” method. For example, the lubricational toner image may be formed without the charging process. That is, as long as the peripheral surface of the photosensitive drum 1 can be supplementally provided with lubricational toner, the method for delivering supplementary lubricational toner does not need to be limited to the method employed in this embodiment.

### 1-3: Toner Expulsion Process

As the development unit 40 is used, the toner in the development unit 40 is gradually deteriorated by the usage. Thus, as the development unit 40 increases in its cumulative usage, the phenomenon that the deteriorated toner fails to be transferred from the development roller 4a onto the peripheral surface of the photosensitive drum 1 occurs. That is, the deteriorated toner remains adhered to the peripheral surface of the development roller 4a. If the development unit 40 which is in this condition is continuously used, it is possible that the deteriorated toner will solidly adhere (in the form of film) to the peripheral surface of the development roller 4a and/or the toner layer thickness regulation blade 4c. This phenomenon is likely to occur when the development unit 40 is continuously used under such a condition that the amount of toner consumption per print is small.

In this embodiment, therefore, in order to prevent the deteriorated toner on the peripheral surface of the development roller 4a from permanently adhering to the peripheral surface of the development roller 4a, and/or from becoming welded to the toner layer thickness regulation blade 4c, a “toner expulsion process” for causing the deteriorated toner on the peripheral surface of the development roller 4a to be forcefully expelled onto the peripheral surface of the photosensitive drum 1 is carried out. As the “toner expulsion process” is carried out, the deteriorated toner remaining on the peripheral surface of the development roller 4a is expelled onto the peripheral surface of the photosensitive drum 1, and forms a rectangular solid black toner image on the peripheral surface of the photosensitive drum 1. This rectangular solid black toner image is not transferred onto a sheet of recording medium by the transfer roller 6, and is recovered by the cleaning apparatus 3 to be disposed. Incidentally, regarding the dimension of the rectangular solid black image formed on the peripheral surface of the photosensitive drum 1, of the deteriorated toner expelled onto the peripheral surface of the photosensitive drum 1 from the development roller 4a, its dimension in terms of the rotational direction of the photosensitive drum 1 (secondary scan direction) has only to be no less than the circumference of the development roller 4a. If it is desired to increase the amount by which the deteriorated toner is to be expelled from the peripheral surface of the development roller 4a, all that is necessary is to increase the length of time the “toner expulsion process” is carried out. In this embodiment, the deteriorated toner on the peripheral surface of the development roller 4a is expelled by carrying out the ‘toner expulsion process” long enough to form a solid black toner image, the dimension of which in terms of the direction rotational direction of the development roller 4a is equal to the circumference of the development roller 4a.

Also in this embodiment, the number of rotations of the development roller 4a is cumulatively counted, and is stored as the toner expulsion index, in the DT memory 40m. That is, if the toner expulsion index (count) reaches a preset threshold value, the “toner expulsion process” is carried out. At the end of the “toner expulsion process”, the counter for the cumulative rotations of the development roller 4a is reset to start cumulatively counting the rotations of the development roller 4a so that the “toner expulsion process” can be periodically carried out. The timing for the “toner expulsion process” does not need to be based on the cumulative number of the rotations of the development roller 4a. For example, it may be carried out according to the remaining amount of toner in the development unit 40, print count (image formation count), or the like.

### 1-4: Structure of Controlling Apparatus

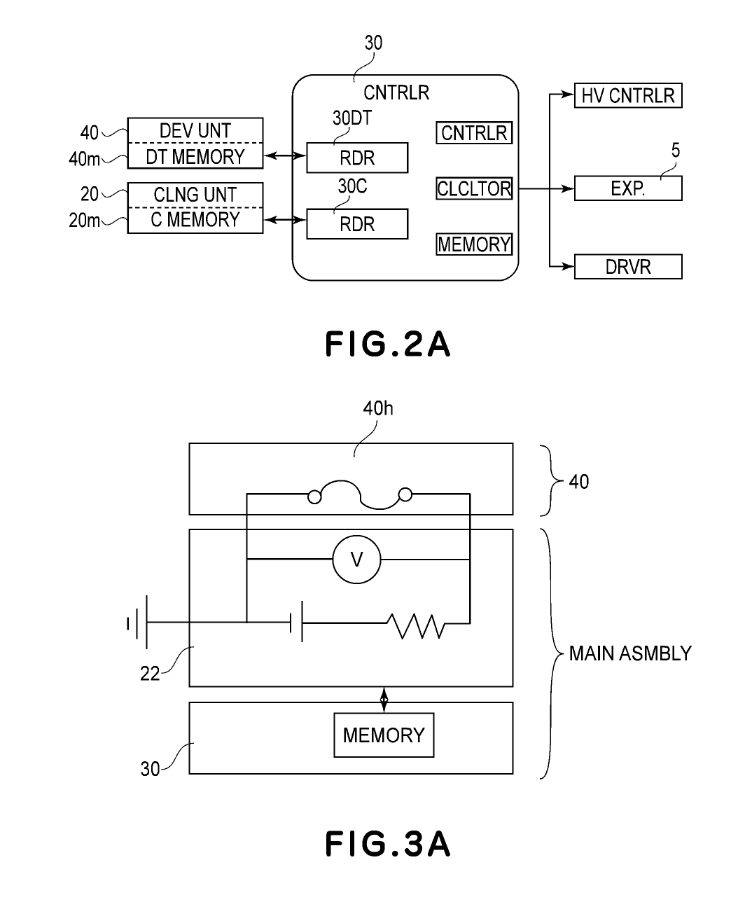

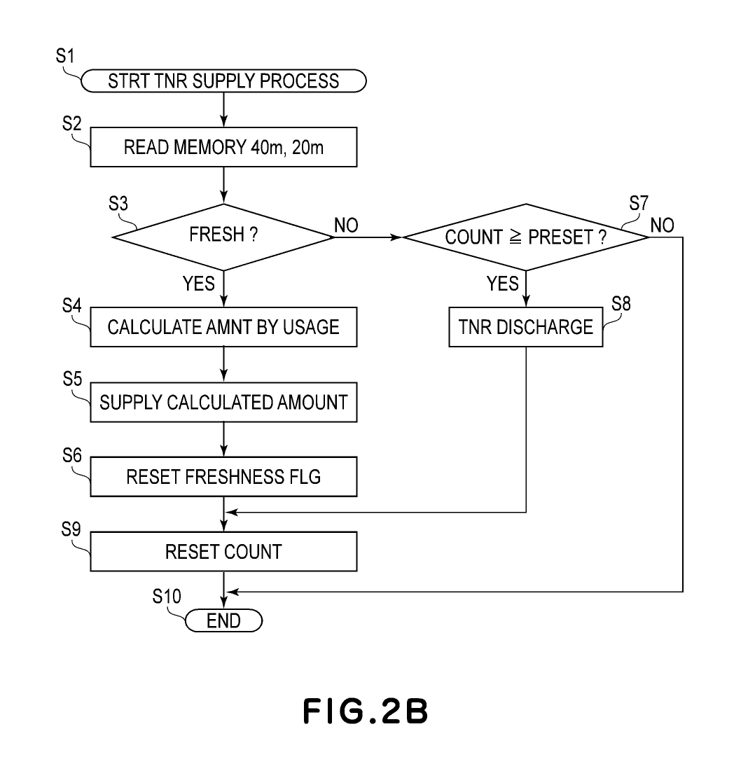

Next, referring to FIG. 2A, the structure of the controlling apparatus 30 in this embodiment is described. FIG. 2A is a block diagram of the structure of the controlling apparatus 30.

The controlling apparatus 30 is provided with a pair of reading portions 30DT and 30c, which communicate with the DT memory 40m and C memory 20m, respectively. It also internally holds a controlling portion, a computing portion, and a memory portion. It is the controlling apparatus 30, structured as described above that controls driving of the high voltage control system, exposing apparatus 5, and driving system of the image forming apparatus. Because the controlling apparatus 30 is structured as described above, it is possible for the controlling portion 30 to estimate the extent of deterioration of the toner in the development unit 40, based on the cumulative amount of usage of the development unit 40, which is stored in the DT memory 40m, for example, and then, to change the length of time the peripheral surface of the photosensitive drum 1 is exposed to form a lubricational toner image, based on the estimated degree of the toner deterioration. Incidentally, the information read from the DT memory 40m and C memory 20m can be stored in the abovementioned memory portion of the controlling apparatus 30.

### 1-5: Control Sequence Flow

Next, referring to FIG. 2B, the control of the sequence for lubricational toner delivery in this embodiment is described. FIG. 2B is a flowchart of the “lubricational toner delivery process” in this embodiment.

As the main power source of the apparatus main assembly is turned on, or the controlling apparatus 30 of the main assembly of the image forming apparatus detects that the door H has just been opened and closed, the controlling portion 30 starts the “lubricational toner delivery process” (S1). As it starts the lubricational toner delivery process, it reads the cumulative amount of usage of the development unit 40 from the DT memory 40m (it is cumulative number of rotations of development roller 4a that is read here, but, it may be residual amount of toner in development unit 40 or cumulative print count). Further, the controlling apparatus 30 determines, based on the information in the C memory 20m, whether or not the cleaning unit 20 in the apparatus main assembly is brand-new (S2 and S3).

If the controlling apparatus 30 determines that the cleaning unit 20 is brand-new (Yes in S3), it determines that there is no toner in the area of contact between the cleaning blade 3a and the peripheral surface of the photosensitive drum 1, and computes the amount by which toner is to be delivered to the peripheral surface of the photosensitive drum 1 to lubricate the peripheral surface of the photosensitive drum 1. The computation is made so that the amount reflects (is proportional to) the cumulative number of rotations of the development roller 4a, which is stored in the DT memory 40m. That is, based on the assumption that the greater the cumulative number of rotations of the development roller 4a, the greater the extent of the deterioration of the toner in the development unit 40, the controlling apparatus 30 controls the “lubricational toner delivery process” so that the greater the cumulative number of rotations of the development roller 4a, the greater the amount by which toner is to be delivered for lubrication from the development unit 40 to the peripheral surface of the photosensitive drum 1 (S4). As soon as the amount by which toner is to be delivered for lubrication is obtained by the computation, a lubricational toner image is formed on the peripheral surface of the photosensitive drum 1 (S5). Incidentally, in the “lubricational toner delivery process”, in order to prevent the lubricational toner image on the peripheral surface of the photosensitive drum 1 from being transferred onto a sheet of recording medium, no voltage is applied to the transfer roller 6 (or voltage which is the same in polarity as toner is applied to transfer roller 6). As soon as the lubricational toner image is formed, the information in the C memory 20, which indicates that the cleaning unit 20 in the apparatus main assembly is brand-new, is rewritten (S6). Thus, as the controlling apparatus 30 reads the C memory 20m thereafter, it determines that the cleaning unit 20 in the apparatus main assembly has been used. Then, it resets the toner expulsion index (count) in the DT memory 40m, and ends the lubricational toner delivery process (S10).

On the other hand, if the controlling apparatus 30 determines that the cleaning unit in the apparatus main assembly is not brand-new (No in S3), the lubricational toner is not delivered from the development unit 40, because there is the residual toner, or the like, resulting from toner image transfers, in the area of contact between the cleaning blade 3a, which has been in use, and peripheral surface of the photosensitive drum 1, and therefore, it is unnecessary to immediately deliver lubrication toner to the area of contact from the development unit 40. However, it is possible that pieces of film of deteriorated toner will have solidly adhered to the peripheral surface of the development roller 4a (filming phenomenon), and/or will have been welded to the toner layer thickness regulation blade 4c. Therefore, the controlling apparatus 30 determines whether or not the toner expulsion index (count) is no less than the preset threshold value (S7). If the toner expulsion index (count) is no less than the preset threshold value, the controlling apparatus 30 determines that the toner expulsion process needs to be carried out. Then, the controlling apparatus 30 causes the development roller 4a to expel the toner on the peripheral surface of the development roller 4a, onto the peripheral surface of the photosensitive drum 1 (S8). Then, the deteriorated toner on the peripheral surface of the photosensitive drum 1 is recovered by the cleaning apparatus 3. Thereafter, the controlling apparatus resets the DT memory 40m in terms of the toner expulsion index (count) (S9), and ends the “lubricational toner delivery process” (S10). On the other hand, if the controlling apparatus 30 determines in S7 that the toner expulsion index (count) is no more than the preset threshold value, it determines that it is unnecessary to carry out the toner expulsion process. Then, it ends the “lubricational toner delivery process” (S10).

As soon as the lubricational toner delivery process is carried out following the flowchart described above, the image formation process is started. Then, if the main electric power source of the apparatus main assembly is turned on, or the controlling apparatus 30 detects that the door H has just been opened and closed, it initiates the lubricational toner delivery process again.

As described above, in this embodiment, the amount by which toner is delivered from the development unit 40 to the peripheral surface of the photosensitive drum 1 solely for the lubrication of the peripheral surface of the photosensitive drum 1 is determined based on the cumulative amount of usage of the development unit 40; it is determined in proportion to the cumulative amount of usage of the development unit 40. Therefore, even if the toner in the toner container deteriorates, the peripheral surface of the photosensitive drum 1 remains satisfactorily lubricated, and therefore, the friction between the cleaning blade 3a and the peripheral surface of the photosensitive drum 1 remains satisfactorily small. Further, when the development unit 40 in the apparatus main assembly is in the early stage of its usage, the peripheral surface of the photosensitive drum 1 can be satisfactorily lubricated by delivering a relatively small amount of toner to the peripheral surface of the photosensitive drum 1 from the development unit 40. Therefore, it does not occur that toner consumption is unnecessarily accelerated by the toner delivery for lubrication.

As will be evident from the above given detailed description of this preferred embodiment of the present invention, the present invention can provide an image forming apparatus which is enabled to deliver toner to the peripheral surface of its image bearing member to lubricate the peripheral surface of the photosensitive drum 1 in order to reduce the friction between its cleaning blade and the peripheral surface of the image bearing member, and the characteristic feature of which is that it can satisfactorily reduce the friction between the cleaning blade and the peripheral surface of the image bearing member regardless of the cumulative amount of usage of the development unit in the apparatus main assembly.

### Embodiment 2

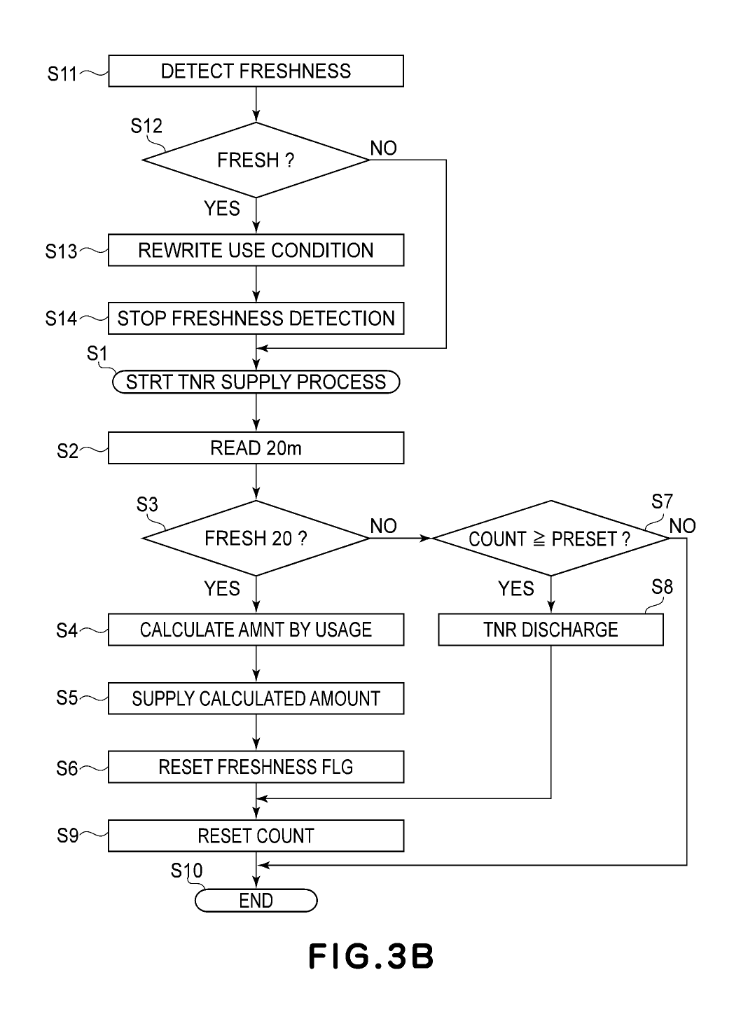

Next, referring to FIGS. 3A and 3B, the second preferred embodiment of the present invention is described. The structural features of the image forming apparatus in this embodiment, which are the same as those in the first preferred embodiment are not going to be described. That is, only the features of the image forming apparatus in this embodiment, which are different from the counterparts in the first embodiment are going to be described.

### 2-1: Portion for Detecting Cumulative Amount of Usage of Development Unit

First, referring to FIG. 3A, the general structure of the development unit status (usage) detecting portion in this embodiment is described. In the first embodiment, the information regarding whether or not the development unit 40 in the main assembly of an image forming apparatus is brand-new is stored in the DT memory 40m of the development unit 40. In this embodiment, however, the information regarding whether or not the development unit 40 in the apparatus main assembly is brand-new is stored in the memory of the controlling apparatus 30 of the apparatus main assembly. Thus, the information regarding the history of the usage of the development unit 40, which is in the memory of the controlling apparatus 30 of the apparatus main assembly has to be rewritten each time the development unit 40 in the apparatus main assembly is replaced. If the information is not rewritten, the lubricational toner delivery process will be carried out based on the information regarding the replaced development unit 40 even after the installation of a brand-new development unit 40. In this embodiment, therefore, the apparatus main assembly is provided with a development unit status detecting portion for determining whether or not the development unit 40 in the apparatus main assembly is brand-new. If the development unit 40 in the apparatus main assembly is brand-new, the information in the memory of the controlling apparatus 30 is rewritten.

The development unit status detecting portion comprises a fuse circuit 40h of the development unit 40, and the sensor portion 22 (sensor circuit) of the apparatus main assembly. The sensor portion 22 has a constant voltage power source and a resistor. When the development unit 40 in the apparatus main assembly is brand-new, there is electrical connection between the fuse circuit 40h and the sensor portion 22 through the electrical contacts of the development unit 40. More specifically, one end of the fuse circuit 40h is grounded, and the other end is in connection to the constant voltage power source of the sensor portion 22. Thus, if the sensor portion 22 detects that the fuse circuit 40h is not blown, the controlling apparatus 30 determines that the development unit 40 in the apparatus main assembly is brand-new. Then, it stores this information in its memory. On the other hand, as soon as the brand-new development unit in the apparatus main assembly is used for the first time, the actual fuse portion of the fuse circuit 40h is blown (melted away) by an unshown fuse melting means, breaking the electrical connection between the constant voltage power source and sensor portion 22. Thus, the controlling apparatus 30 determines that the development unit 40 in the apparatus main assembly is not brand-new (it has been in use), and stores this information in the memory. Next, the lubricational toner delivery process in this embodiment is concretely described with reference to the appended flowchart.

### 2-2: Lubrication Toner Delivery Process

Next, referring to FIG. 3B, the lubrication toner delivery process in this embodiment is described. FIG. 3B is a flowchart of the “lubricational toner delivery process” in this embodiment.

As the main power source of the apparatus main assembly is turned on, or the controlling apparatus 30 detects that the door H has just been opened and closed, it uses the development unit status detecting portion to determine whether or not the development unit 40 in the apparatus main assembly is brand-new (S11 and S12). More specifically, it is determines by the sensor portion 22 whether or not the fuse circuit 40h is intact in terms of electrical connection. If it determines that the fuse circuit 40h is intact, it determines that the development unit 40 is brand-new (Yes in S12). Then, it replaces the information regarding the status of the development unit 40 in terms of usage, which is in the memory of the controlling apparatus 30, with new information (development unit is brand-new) (S13). Then, it melts away the fuse of the fuse circuit 40h (S14), ending thereby the process for determining whether or not the development unit 40 in the apparatus main assembly is brand-new. Then, it starts the “lubricational toner delivery process” (S1).

On the other hand, if it is not detected that the fuse circuit 40h is intact in terms of electrical connection, and therefore, it is determined that the development unit 40 in the apparatus main assembly is not brand-new (No in S3), the process for detecting whether or not the development unit 40 is brand-new is immediately ended, and the “lubricational toner delivery process” is started (S1).

As the controlling apparatus 30 of the apparatus main assembly starts the “lubricational toner delivery process”, it determines, based on the information in the C memory 20m, whether or not the cleaning unit 20 in the apparatus main assembly is brand-new (S2 and S3).

If the controlling apparatus 30 determines that the cleaning unit 20 is brand-new (Yes in S3), it determines that there is no toner in the area of contact between the cleaning blade 3a and the peripheral surface of the photosensitive drum 1, and calculates the amount by which toner is to be delivered to the peripheral surface of the photosensitive drum 1 to lubricate the peripheral surface of the photosensitive drum 1. More specifically, the amount is calculated based on the information regarding the cumulative amount of usage of the development unit 40, which is in the memory of the controlling apparatus 30 (S4).

As soon as the amount by which toner is to be delivered for lubrication is obtained by the computation, a lubricational toner image is formed on the peripheral surface of the photosensitive drum 1 (S5). Incidentally, in the lubricational toner delivery process, in order to prevent the lubricational toner image on the peripheral surface of the photosensitive drum 1 from being transferred onto a sheet of recording medium, no voltage is applied to the transfer roller 6 (or voltage which is the same in polarity as toner is applied to transfer roller 6). As soon as the lubricational toner image is formed, the information in the C memory 20, which indicates that the cleaning unit 20 in the apparatus main assembly is brand-new, is rewritten (S6). Then, the controlling apparatus 30 resets the toner expulsion index (count) in the DT memory 40m, and ends the lubricational toner delivery process (S10).

On the other hand, if the controlling apparatus 30 determines that the cleaning unit 20 in the apparatus main assembly is not brand-new (No in S3), the toner dedicated to the lubrication of the peripheral surface of the photosensitive drum 1 is not delivered from the development unit 40, because there is the residual toner, or the like, resulting from toner image transfer, in the area of contact between the cleaning blade 3a, which has been in use, and peripheral surface of the photosensitive drum 1, and therefore, it is unnecessary to immediately deliver lubrication toner to the area of contact from the development unit 40. However, it is possible that pieces of film of deteriorated toner will have solidly adhered to the peripheral surface of the development roller 4a (filming phenomenon), and/or will have been welded to the toner layer thickness regulation blade 4c. Therefore, the controlling apparatus 30 determines whether or not the toner expulsion index (count) is no less than a preset threshold value (S7). If the toner expulsion index (count) is no less than the preset threshold value, the controlling apparatus 30 determines that the toner expulsion process needs to be carried out. Then, the controlling apparatus 30 causes the development roller 4a to expel the toner on the peripheral surface of the development roller 4a, onto the peripheral surface of the photosensitive drum 1 (S8). Then, the deteriorated toner on the peripheral surface of the photosensitive drum 1 is recovered by the cleaning apparatus 3. Thereafter, the controlling apparatus 30 resets the DT memory 40m in terms of the toner expulsion index (count) (S9), and ends the lubricational toner delivery process (S10). On the other hand, if the controlling apparatus determines in S7 that the toner expulsion index (count) is no more than the preset threshold value, it determines that it is unnecessary to carry out the toner expulsion process. Then, it ends the lubricational toner delivery process (S10).

As soon as the lubricational toner delivery process is carried out following the flowchart described above, the image formation process is started. Then, if the main electric power source of the apparatus main assembly is turned on, or the controlling apparatus 30 detects that the door H has just been opened and closed, it initiates the lubricational toner delivery process again.

As described above, in this embodiment, the information about the development unit 40 is stored in the controlling apparatus 30 of the apparatus main assembly, and the amount by which toner is to be delivered solely for lubrication is controlled based on this information. Further, each time the lubricational toner delivery process is carried out, the information about the status of the development unit 40 in terms of usage is rewritten. Since the image forming apparatus is structured as described above, even if the toner in the development unit 40 deteriorates, the peripheral surface of the photosensitive drum 1 can be satisfactorily lubricated to reduce the friction between the cleaning blade 3a and the peripheral surface of the photosensitive drum 1. Further, when the development unit 40 in the apparatus main assembly is in the early stage of its usage, the peripheral surface of the photosensitive drum 1 can be satisfactorily lubricated by delivering a relatively small amount of toner to the peripheral surface of the photosensitive drum 1 from the development unit 40. Therefore, it does not occur that toner consumption is unnecessarily accelerated by the toner delivery for lubrication.

As will be evident from the detailed description of this preferred embodiment of the present invention, the present invention can provide an image forming apparatus which is enabled to deliver toner to the peripheral surface of its image bearing member to lubricate the peripheral surface of the photosensitive drum 1 in order to reduce the friction between its cleaning blade and the peripheral surface of the image bearing member, and the characteristic feature of which is that it can satisfactorily reduce the friction between the cleaning blade and the peripheral surface of the image bearing member regardless of the cumulative amount of usage of the development unit in the apparatus main assembly.

### Embodiment 3

### 3-1: Structure

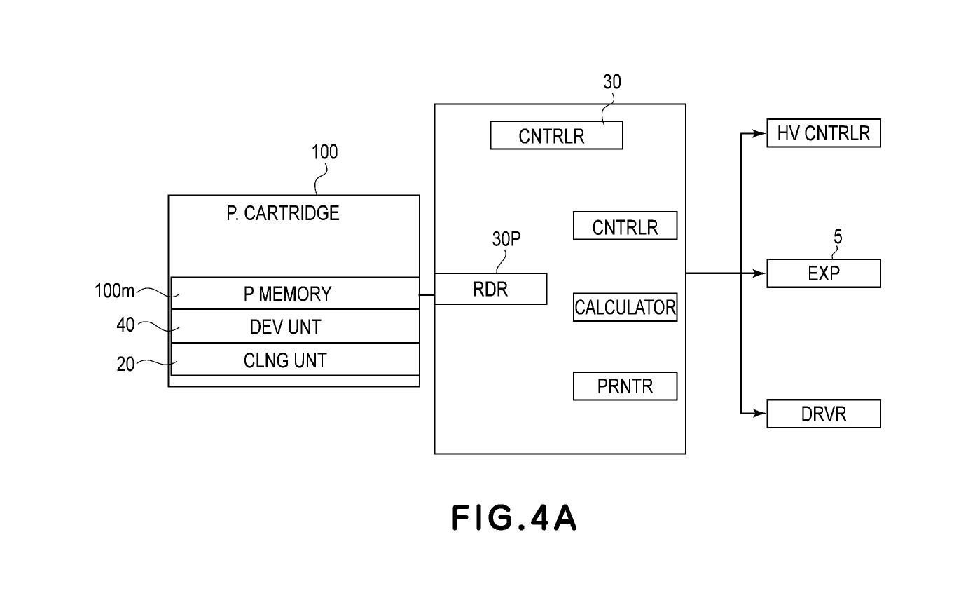

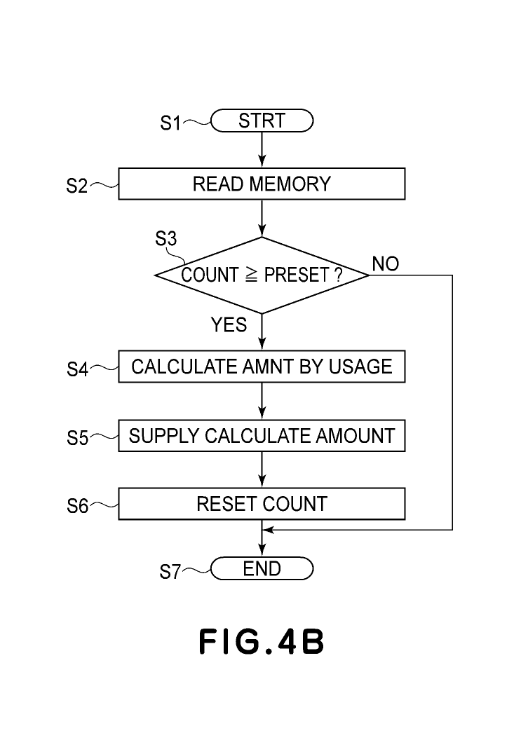

Next, referring to FIG. 4A, the third preferred embodiment of the present invention is described. The structural features of the image forming apparatus in this embodiment, which are the same as those in the first preferred embodiment are not going to be described. That is, only the features of the image forming apparatus in this embodiment, which are different from the counterparts in the first embodiment are going to be described.

In the first embodiment, the cleaning unit 20 and development unit 40 are structurally independent from each other. In this embodiment, however, the photosensitive drum charge roller 2, development unit 40, and cleaning apparatus 3 are integrated as a process cartridge 100 which is removably mountable in the main assembly of the image forming apparatus. The process cartridge 100 is provided with a nonvolatile memory (which hereafter will be referred to as P memory 100m) for storing the cumulative amount of usage of the process cartridge 100. In the first embodiment, a part of the information such as the cumulative number of rotations of the development roller 4a is stored in C memory 20m, whereas the other part is stored in the DT memory 40m. In this embodiment, however, the entirety of the information is stored in the P memory 100m. Also in this embodiment, the information about whether or not the cleaning unit 20 in the apparatus main assembly is brand-new is not necessary. Instead, the controlling apparatus 30 in this embodiment uses a toner delivery counter, which stores the cumulative number of rotations of the photosensitive drum 1. Incidentally, during the manufacturing of a process cartridge (100), the toner delivery counter may be set to a value which is greater than the preset threshold value for the “lubrication toner delivery process” to ensure that when the process cartridge (100) in the apparatus main assembly is brand-new, the “lubrication toner delivery process” never fails to be carried out before the starting of the image forming operation.

### 3-2: Lubricational Toner Delivery Process

In this embodiment, as the main power source of the apparatus main assembly, which has been off, is turned on; it is detected by the controlling apparatus 30 that the door H has just been opened and closed; or an image formation process is ended, the “lubricational toner delivery process” is started. The “lubricational toner delivery process” is a process in which it is determined whether or not the peripheral surface of the photosensitive drum 1 needs to be supplied with toner dedicated to lubrication, and if the peripheral surface of the photosensitive drum 1 needs to be supplied with toner for lubrication, it is supplied with toner. In the case of the “lubricational toner delivery process” in this embodiment, if the toner delivery count, which will be described later, reaches a preset threshold value, the peripheral surface of the photosensitive drum 1 is supplied with toner just to lubricate the peripheral surface of the photosensitive drum 1. In this embodiment, the “lubricational toner delivery process” is carried out while no image is formed. After toner is delivered to the peripheral surface of the photosensitive drum 1 solely for the lubrication of the peripheral surface of the photosensitive drum 1, this toner is delivered to the area of contact between the cleaning blade 3a and the peripheral surface of the photosensitive drum 1 by the rotation of the photosensitive drum 1, and lubricates the area of contact.

The toner delivery count, which is obtained by calculation from the cumulative number of rotations of the photosensitive drum 1 is stored in the P memory 100m. As the lubricational toner delivery count reaches the preset threshold value, the “lubricational toner delivery”. that is, the toner delivery for lubricating the peripheral surface of the photosensitive drum 1, is carried out. As soon as the “lubricational toner delivery process” is completed, the toner delivery counter is reset. Then, as the toner delivery count reaches the preset threshold value due to the rotational driving of the photosensitive drum 1 in the following image formation process or the like, the “lubricational toner delivery sequence” is carried out again. The reason why the “lubricational toner delivery process” is carried out is as follows. The rotation of the photosensitive drum 1 causes some toner particles which are functioning as lubricant in the area of contact between the cleaning blade 3a and the peripheral surface of the photosensitive drum 1, to slip out of the area of contact, reducing thereby the number of the toner particles functioning as lubricant in the area of contact between the cleaning blade 3a and the peripheral surface of the photosensitive drum 1. If the area of contact extremely reduces in the number of the toner particles functioning as lubricant, it is possible that the cleaning blade 3a will shudder or chatter. Thus, as the cumulative length of time the process cartridge 100 in the image forming apparatus is used reaches the preset threshold value, toner is delivered to the area of contact between the cleaning blade 3a and the peripheral surface of the photosensitive drum 1, solely for lubrication to reduce the friction between the two. Whether or not the cumulative usage of a process cartridge is long enough, or the cumulative number of rotations of the photosensitive drum 1 is large enough, for the lubricational toner delivery process to be carried out, is determined based on the toner delivery count and the preset threshold value. Incidentally, the threshold value for the toner delivery count has only to be set based on the information about the photosensitive drum 1. For example, the greater the cumulative number of the prints formed with the use of a process cartridge, the greater the cumulative number of rotations of the photosensitive drum 1 in the process cartridge. Therefore, the threshold value for the toner delivery count may be set for the cumulative number of the prints formed by the process cartridge in the apparatus main assembly.

In this embodiment, the amount by which toner is delivered by the “lubricational toner delivery process” is adjustable. More concretely, the extent of deterioration of the toner in the development unit 40 is estimated from the cumulative amount of usage of the development unit 40, which is stored in the P memory 100m. Then, the amount by which toner is delivered solely for lubrication is determined in proportion to the extent of the toner deterioration. In this embodiment, the amount by which toner is delivered solely for lubrication is increased by increasing the length of time the peripheral surface of the photosensitive drum 1 is exposed to form a lubricational tone image.

### 3-3: Lubrication Toner Delivery Process

Next, referring to FIG. 4B, the lubrication toner delivery sequence in this embodiment is described. FIG. 4B is a flowchart of the “lubricational toner delivery process” in this embodiment.

As the main power source of the apparatus main assembly, which has been off, is turned on; it is detected by the controlling apparatus 30 that the door H has just been opened and closed; or an image formation process is ended, the controlling apparatus 30 of the main assembly of the image forming apparatus starts the “lubricational toner delivery process” (S1). As it starts the lubricational toner delivery process, it reads the cumulative usage of the process cartridge 100 from the P memory 100 (S2). Then, the controlling apparatus 30 determines whether or not the cumulative toner delivery count is no less than a preset threshold value (S3). If the cumulative toner delivery count is no less than the preset threshold value (Yes in S3), the controlling apparatus 30 determines that there is virtually no toner in the area of contact between the cleaning blade 3a and the peripheral surface of the photosensitive drum 1, and starts the lubricational toner deliver process. Incidentally, during the manufacturing of a process cartridge (100), the toner delivery count may be set to a value greater than the preset threshold value for lubricational toner delivery to ensure that if the process cartridge 100 in the apparatus main assembly is brand-new, the lubricational toner delivery process is carried out. If the controlling apparatus 30 determines that the “lubricational toner delivery process” needs to be carried out, it obtains by calculation the amount by which toner is to be delivered solely for lubrication, based on the cumulative amount of usage of the development unit 40, which is stored in the P memory 100m. That is, the amount by which toner is to be delivered solely for lubrication is determined based on the cumulative number of rotations of the development roller 4a, which is stored in the P memory. More specifically, the controlling apparatus 40 determines that the greater the cumulative number of rotations of the development roller 4a, the more advanced the toner deterioration, and controls the amount by which toner is to be delivered, so that the greater the cumulative number of rotations of the development roller 4a, the greater the amount by which toner is to be delivered solely for lubrication (S4). As soon as the amount by which toner is to be delivered solely for lubrication is obtained by calculation, a toner image for lubrication is formed on the peripheral surface of the photosensitive drum 1 (S5). Incidentally, in order to prevent the lubricational toner image on the peripheral surface of the photosensitive drum 1 from being transferred onto a sheet of recording medium, no voltage is applied to the transfer roller 6 (or voltage which is the same in polarity as toner is applied to transfer roller 6). As soon as the lubricational toner image is formed, it is delivered to the area of contact between the photosensitive drum 1 and cleaning blade 3a. Then, the controlling apparatus 30 resets the toner delivery counter for image formation, in the P memory 100m (S9), and ends the “lubricational toner delivery process” (S10).

On the other hand, if the cumulative process cartridge usage count is no more than the preset threshold value (No in S3), the controlling apparatus 30 determines that the lubrication toner delivery is unnecessary, and ends the “lubricational toner delivery process” (S10).

As soon as the “lubricational toner delivery process” is ended as shown by the above described flowchart, the controlling apparatus 30 puts the image forming apparatus on standby. Thereafter, if the main power source of the image forming apparatus, which has been off, is turned on; the controlling apparatus 30 detects that the door H has just been opened and closed; or an image forming process is ended, the controlling apparatus 30 carries out the “lubricational toner delivery process” again.

As described above, in this embodiment, the amount by which toner is delivered solely for lubrication to the peripheral surface of the photosensitive drum 1 from the development unit 40 is determined based on the cumulative amount of usage of the development unit 40. That is, the greater the cumulative amount of usage of the development unit 40, the greater the amount by which toner is delivered solely for lubrication. Therefore, even if the toner in the development unit 40 is deteriorated by usage, the friction between the cleaning blade 3a and the peripheral surface of the photosensitive drum 1 can be satisfactorily reduced. Further, when the development unit 40 in the apparatus main assembly is in the early stage of usage, the amount by which toner is delivered to lubricate the peripheral surface of the photosensitive drum is relatively small, and therefore, it is not likely for the “lubricational toner delivery process” to unnecessarily accelerate toner consumption.

### Embodiment 4

### 4-1: Structure

Next, referring to FIGS. 4A and 4B, the fourth preferred embodiment of the present invention is described. The structural features of the image forming apparatus in this embodiment, which are the same as those in the first preferred embodiment are not going to be described. That is, only the features of the image forming apparatus in this embodiment, which are different from the counterparts in the first embodiment are going to be described.

Referring to FIG. 1(b), the above described development unit 40 and cleaning unit 20 (cleaning apparatus 3) are structured so that they can be removably mountable in the main assembly of the image forming apparatus. The cleaning unit 20 is provided with a nonvolatile memory (which hereafter will be referred to as C memory 20m) which stores the cumulative amount of usage of the cleaning apparatus 20 (cumulative amount of toner delivery). The development unit 40 is provided with a nonvolatile memory (which hereafter will be referred to as DT memory 40m) which stores the cumulative amount of usage of the development unit 40 (cumulative number of rotations of development roller 4a). Further, in this embodiment, the information about whether or not the cleaning unit 20 in the apparatus main assembly is brand-new is not required. Instead, the cleaning unit 20 is provided with a toner delivery counter, in which the cumulative number of rotations of the photosensitive drum 1 is stored. Incidentally, the during the manufacturing of a cleaning unit (20), the toner delivery counter may be set to a value which is greater than a preset threshold value to ensure that when the cleaning unit (20) in the apparatus main assembly is brand-new, the “lubricational toner delivery process” never fails to be carried out.

### 4-2: Lubricational Toner Delivery Process

Next, referring to FIG. 4B, the lubricational toner delivery sequence in this embodiment is described. FIG. 4B is a flowchart of the “lubricational toner delivery process” in this embodiment.

As the main power source of the apparatus main assembly is turned on; the controlling apparatus 30 detects that the door H has just been opened and closed; or an image formation process is ended, the “lubricational toner delivery process” is started (S1). As the “lubricational toner delivery process” is started, the controlling apparatus 30 of the apparatus main assembly reads the cumulative toner delivery count from the C memory 20m, and the cumulative amount of usage of the development unit 40 from the DT memory 40m (S2). Then, the controlling apparatus 30 determines whether or not the lubricational toner delivery process needs to be carried out, based on the whether or not the cumulative toner delivery count is no less than the preset threshold value (S3). Since the value in the cumulative toner delivery count in a brand-new cleaning unit 20 is greater than the preset threshold value, it is ensured that when the cleaning unit 20 in the apparatus main assembly is brand-new, the “lubricational toner delivery process” never fails to be carried out.

If the cumulative toner delivery count is no less than the preset threshold value, the controlling apparatus 30 determines that the “lubricational toner delivery process” needs to be carried out, that is, there is no toner in the area of contact between the cleaning blade 3a and the peripheral surface of the photosensitive drum 1 (Yes in S3). Then, it obtains by calculation the amount by which toner is to be delivered solely for lubrication to the peripheral surface of the photosensitive drum 1, based on the cumulative amount of usage of the development unit 40, which it read from the DT memory 40m. More specifically, it determines the amount, based on the cumulative number of rotations of the development roller 4a, which is stored in the DT memory 40m. That is, it determines that the greater the cumulative number of rotations of the development roller 4a, the more advanced the deterioration of toner, and controls the “lubricational toner delivery process” so that the greater the cumulative number of rotations of the development roller 4a, the greater the amount by which toner is to be delivered solely for lubrication (S4). As soon as the amount by which toner is to be delivered solely for lubrication is obtained by calculation, the controlling apparatus 30 forms a lubricational tone image on the peripheral surface of the photosensitive drum 1 (S5). Incidentally, in the “lubricational toner delivery process”, in order to prevent the lubrication tone image on the peripheral surface of the photosensitive drum 1 from being transferred onto a sheet of recording medium, no voltage is applied to the transfer roller 6 (or voltage which is the same polarity as toner is applied).

Thereafter, the controlling apparatus 30 resets the cumulative toner delivery counter in the C memory 20m (S6), and ends the “lubricational toner delivery process” (S7).

On the other hand, if the controlling apparatus 30 determines in S3 that the cumulative toner delivery count is not less than the preset threshold value, it determines that the “lubricational toner delivery process” does not need to be carried out (No in S3), and ends the “lubricational toner delivery process” (S7).

After the completion of the “lubricational toner delivery process” described above with reference the flowchart in FIG. 4B, the controlling apparatus 30 puts the image forming apparatus on standby. Thereafter, if the main power source, which was off, is turned on; the controlling apparatus 30 detects that the door H has just been opened and closed; or an image formation process is ended, the controlling apparatus 30 carries out the “lubricational toner delivery process” again.

As described above, in this embodiment, the amount by which toner is delivered, solely for lubrication, to the peripheral surface of the photosensitive drum 1 is determined based on the cumulative usage of the development unit 40. That is, the amount by which toner is delivered to the peripheral surface of the photosensitive drum 1 so that the greater the cumulative amount of usage of the development unit 40, the greater the amount by which toner is to be delivered in the “lubricational toner delivery process”. Therefore, even if the toner in the development unit 40 is deteriorated due to the usage of the development unit 40, the peripheral surface of the photosensitive drum 1 is satisfactorily lubricated to reduce the friction between the cleaning blade 3a and the peripheral surface of the photosensitive drum 1. Further, in this embodiment, the amount by which toner is to be delivered in the “lubricational toner delivery process” when the development unit 40 in the apparatus main assembly is in the early stage of usage is relatively small, it is unlikely for toner consumption to be unnecessarily accelerated.

### Miscellaneous Embodiments

The first to fourth preferred embodiments of the present invention were described above with reference to an image forming apparatus which forms monochromatic images with the use of a single photosensitive drum 1. However, the present invention is also applicable to a full-color image forming apparatus which employs multiple development units, the number of which is equal to the number of primary colors, based on which the apparatus forms a full-color image.

In the first to fourth embodiments, the image forming apparatus is structured so that a toner image is directly transferred from the peripheral surface of the photosensitive drum 1 onto a sheet of recording medium, in the transfer nip. However, the present invention is also applicable to an image forming apparatus which transfers (first transfer) a toner image onto the intermediary transfer belt, and then, transfers (second transfer) the toner image from the intermediary transfer belt, onto a sheet of recording medium. It can also be applied to an image forming apparatus which transfers a toner image onto a sheet of recording medium which is conveyed to the transfer nip by being borne by the recording medium conveyance belt.

Also in the first to fourth embodiments, the cleaning unit 20 (or process cartridge 100) which has the photosensitive drum 1, is removably mountable in the main assembly of the image forming apparatus, and it is when the cleaning unit in the apparatus main assembly is brand-new that lubricational toner is delivered to the peripheral surface of the photosensitive drum 1. However, the present invention is compatible with an image forming apparatus, the main assembly of which does not have the photosensitive drum 1, and the cleaning blade 3a of which is replaceable. In the case of such an image forming apparatus, the same effects as those described above can be obtained by delivering the lubricational toner to the peripheral surface of the photosensitive drum 1 immediately after the cleaning blade 3a is replaced.

Further, regarding the method for obtaining by calculation the cumulative amount of usage of the development unit 40, the method used in the first embodiment to calculate the cumulative amount of usage of the development unit, based on the cumulative number of rotations of the development roller 4a, remaining amount of toner in the development unit, cumulative print count (cumulative number of images formed) is compatible with the second to fourth embodiment. That is, the cumulative usage of the development unit is proportional to the cumulative number of rotations of the development roller and cumulative print count, and is inversely proportional to the remaining amount of toner in the development unit. Further, these indices may be used in combination. In essence, all that is necessary is that the cumulative usage of the development unit, which is related to the extent of toner deterioration, can be obtained by calculation.

While the invention has been described with reference to the structures disclosed herein, it is not confined to the details set forth, and this application is intended to cover such modifications or changes as may come within the purposes of the improvements or the scope of the following claims.

This application claims priority from Japanese Patent Applications Nos. 289390/2009 and 278410/2010 filed Dec. 21, 2009 and Dec. 14, 2010, respectively, which are hereby incorporated by reference.

What is claimed is:

1. An image forming apparatus to which a cleaning unit is detachably mountable to a main assembly of the apparatus, comprising:
a rotatable image bearing member on which an electrostatic latent image is formed;
a developing unit for developing the electrostatic latent image into a toner image by supplying toner onto a surface of said image bearing member;
a cleaning unit including a cleaning blade for removing toner from the surface of said image bearing member by contacting to the surface of said image bearing member when said image bearing member is rotating;
a storing portion for storing information relates to a use amount of said developing unit; and
a control device capable of executing toner supply into between the surface of said image bearing member and said cleaning blade by supplying the toner to the surface of said image bearing member from said developing unit in a period in which image formation on a sheet material is not executed,
wherein when the toner supply is executed, said control device increases the amount of the toner to the surface of said image bearing member from the developing unit with increase of the use amount of said developing unit on the basis of the information stored in said storing portion.

2. An apparatus according to claim 1, wherein said control device executes the toner supply when a fresh cleaning unit is mounted to the main assembly of the apparatus.

3. An apparatus according to claim 1, wherein the toner supply is executed in accordance with the information relating to a number of rotations of said image bearing member.

4. An apparatus according to claim 1, wherein the information relating to the use amount of said developing unit is a number of rotations of a developing roller of said developing unit.

5. An apparatus according to claim 1, wherein the information relating to the use amount of said developing unit is an amount of the toner accommodated in said developing unit.

6. An apparatus according to claim 1, wherein the information relating to the use amount of said developing unit is a number of the sheet materials on which the images are formed.

7. An apparatus according to claim 1, wherein said developing unit is detachably mountable to said main assembly of the apparatus.

8. An image forming apparatus comprising:
a rotatable image bearing member on which an electrostatic latent image is formed;
a developing unit for developing the electrostatic latent image into a toner image by supplying toner onto a surface of said image bearing member;
a cleaning unit including a cleaning blade for removing toner from the surface of said image bearing member by contacting to the surface of said image bearing member when said image bearing member is rotating;
a storing portion for storing information relates to a use amount of said developing unit;
a control device capable of executing toner supply into between the surface of said image bearing member and said cleaning blade by supplying the toner to the surface of said image bearing member from said developing unit in a period in which image formation on a sheet material is not executed, and
wherein when the toner supply is executed, said control device controls such that the amount of the toner to the surface of said image bearing member from the developing unit is increased with increase of the use amount of said developing unit on the basis of the information stored in said storing portion.

9. An apparatus according to claim 8, wherein the toner supply is executed in accordance with the information relating to a number of rotations of said image bearing member.

10. An apparatus according to claim 8, wherein the information relating to the use amount of said developing unit is a number of rotations of a developing roller of said developing unit.

11. An apparatus according to claim 8, wherein the information relating to the use amount of said developing unit is an amount of the toner accommodated in said developing unit.

12. An apparatus according to claim 8, wherein the information relating to the use amount of said developing unit is a number of the sheet materials on which the images are formed.

13. An apparatus according to claim 8, wherein said cleaning unit and said developing unit is detachably mountable to the main assembly of the apparatus.

14. An apparatus according to claim 8, wherein said cleaning unit, said developing unit and said image bearing member are constituted into a process cartridge as a unit which is detachably mountable to the main assembly of the apparatus.
